(19) United States
(12) Patent Application Publication
(10) Pub. No.: US 2010/0330233 A1
(43) Pub. Date: Dec. 30, 2010

(54) LOW FAT PROCESSED CHEESE SLICE-ON-SLICE AND BLOCK

(75) Inventors: Divinia Reyes, Delahey (AU); Neil Griffith Douglas, Brunswick (AU); Kamal Seyed Razavi, Ringwood (AU)

Correspondence Address: FITCH EVEN TABIN & FLANNERY, 120 SOUTH LASALLE STREET, SUITE 1600, CHICAGO, IL, 60603-3406, US

(73) Assignee: KRAFT FOOD GLOBAL BARNDS LLC, Northfield, IL (US)

(21) Appl. No.: 12/495,503

(22) Filed: Jun. 30, 2009

(51) Int. Cl. A23C 19/08; A23C 19/084; A23C 19/082

(52) U.S. Cl. 426/39; 426/582; 426/103; 426/89

(57) ABSTRACT

Low fat (less than 5 percent, but preferably less than 3 percent) cheese slice-on-slice and block products. The product can be made with natural skim milk cheese; additional dairy solids; and have from about 53 to about 55 total weight percent of water; from about 2 to about 2.8 total weight percent of emulsifier salts of at least citrate, such as di-sodium citrate and optionally a phosphate, such as di-sodium phosphate. Citrate/phosphate ratios can be up to about 50/50. The product can have 20 to 30 total weight percent protein, of which from about 12 to 25 total percent weight is functional casein protein; and moisture/functional casein protein ratio from about 22 to 56 percent. Methods to manufacture can include blending and hydrating components before cooking with steam and pressure; followed by vacuum flashing, forming into a sheet or extruding under pressure into a block, and applying an anti-tacking agent.

### FIELD

Low fat processed cheese products, and specifically to a low fat processed cheese product formulated and manufactured in a slice-on-slice or block format.

### BACKGROUND

Processed cheese is conventionally prepared by blending various cheeses and other dairy products with emulsifying salts at elevated temperatures to produce a homogeneous, pumpable, fluid cheese material that can be formed into sheets, slices or other forms, and packaged for consumer use. The substantial milk fat content of processed cheese products not only provides a soft body and texture as well as desirable melt characteristics, but also facilitates the processing at elevated temperatures of the natural cheese components in the manufacturing process. Elimination or even substantial reduction of the fat content of processed cheese can have a detrimental effect on organoleptics (e.g., color, aroma, body, texture and taste) of the resulting product. (See generally, U.S. Pat. No. 5,215,778).

Significant effort has been directed toward the development of reduced fat or substantially fat-free food products that possess characteristics simulating the body, texture, taste, mouth-feel, and the like of its fat-containing counterparts. In some attempts, cellulose materials have been used or proposed to improve organoleptics for a variety of reduced fat or substantially fat-free food products. In spite of these attempts, these processed cheese products can have a pale or translucent color, tough or chewy texture, poor melt characteristics and can result in scorching/browning during baking. (See generally, U.S. Pat. App. 2009/0068311). Additionally, processed cheese products containing substantial levels of cellulose materials can have adverse effects such as mouth-coating or astringency sensations. In short, these products can lack well-rounded organoleptic characteristics.

One additional characteristic of low fat processed cheese is the tendency to have, in varying degrees, an adhesive quality (i.e., stickiness or tackiness). This can include adhesion to manufacturing equipment, other cheese such as in slice-on-slice packaging, or during consumption. To avoid this characteristic in slice-on-slice packaging, low fat or fat-free processed cheese products have typically been produced and packaged in an individually wrapped slice.

While there have been significant advances in the art, further advances are possible and desired. For example, it is desirable to provide improved methods to manufacture nutritious, low calorie, substantially fat-free processed cheese products that have organoleptics simulating conventional processed cheese products. It is also desirable to provide such products in both slice-on-slice and block format for improved manufacturing efficiency and reduction in packaging materials.

### SUMMARY

There is provided herein a low fat processed cheese product with organoleptics simulating conventional processed cheese including formulations suitable for manufacture in slice-on-slice and block formats.

One embodiment can be a low fat processed cheese product having a substantially homogeneous mixture of about 30 to 80 total weight percent of natural skim milk cheese; additional dairy solids; less than about 5.0, but preferably less than 3.0, total weight percent fat; about 45 to about 55 total weight percent of water; from about 2 to about 3 total weight percent of emulsifier salts, the emulsifier salts being at least a citrate salt such as tri-sodium citrate (TSC); from about 20 to 30 total weight percent protein, of which from about 12 to 25 total percent weight can be functional casein protein; and a moisture/functional casein protein ratio from about 22 percent to 56 percent. Additional features can include applying an anti-tacking agent, including but not limited to alginate, lecithin or starch solutions on its surface. Optionally, a phosphate salt, such as di-sodium phosphate (DSP) can be added. When both a citrate and phosphate salt are used, the citrate/phosphate ratio can range up to 50/50

Additional features can include methods to prepare a low fat processed cheese product such as breaking and grinding cheese curds and dairy solids; passing the product through a scanner such as a metal detector; blending dairy solids with a blender, such as a double ribbon blender, with a first group of powders and an amount of water sufficient to hydrate the powders and facilitate homogeneous mixing. The first group of powders can be from about 60 to 90 percent of the total amount desired of milk protein concentrate (MPC), whey powder, citrate, skim milk powder. The methods can include blending in additives such as supplemental nutrients, coloring and preservatives (e.g., beta-carotene, vitamin D, vitamin A, titanium dioxide, and sorbic acid); adding remaining water sufficient to hydrate powders as they are added; blending in citrate and optionally phosphate, salt, and the remaining MPC, whey powder, skim milk powder; standardizing pH of the blend with lactic acid; cooking the blend; vacuum flashing the blend; filtering the blend; chilling the blend; forming the blend into a sheet; and applying an anti-tacking agent to the surface of the sheet. Optionally, the product can be extruded under pressure to form a block of any size.

In one embodiment, the process comprises the step of heating the blend for a hold time and temperature sufficient to achieve desired shear and food safety requirements. For example, such heating can include a temperature between 105° C. to 125° C., under pressure from about 50 kPa to about 150 kPa, for at least 1.5 seconds.

Additional steps can include slitting the sheet into continuous ribbons; cutting the ribbons into individual slices; and stacking the slices (for example, from about 6 to 15 slices) with a 2 to 4 mm alternating overlay; checking the stack of slices for extraneous material; overwrapping the stack of slices in a sealed container; and cooling the container with the stack of slices to 6-15° C.

Other features will become more apparent to persons having ordinary skill in the art to which pertains from the following description and claims.

### BRIEF DESCRIPTION OF THE FIGURES

The foregoing features, as well as other features, will become apparent with reference to the description and figures below, in which like numerals represent elements, and in which:

FIG. 1 is a process flow diagram illustrating a method for a blending and cooking aspect of manufacturing an embodiment of a low fat processed cheese product;

FIG. 2 is a process flow diagram illustrating a method for a slice fill and pack aspect of manufacturing an embodiment of a low fat processed cheese product; and

FIG. 3 is a diagram illustrating a chilling and slitting aspect of manufacturing an embodiment of a low fat processed cheese product.

### DETAILED DESCRIPTION

The embodiments described below provide a low fat processed cheese product with organoleptics simulating conventional processed cheese, manufactured in slice-on-slice and block formats. One embodiment provides 97 percent fat free slice-on-slice and block processed cheese products, though other embodiments can be up to 95 percent fat free. The product can be formulated to vary several characteristics such as, for example, texture depending on market requirements with or without the use of hydrocolloids. As detailed below, the product can result from operating a cooker with the right combination of steam and back pressure to achieve good emulsification and a homogeneous mix. Subsequent controlled cooling can be used to develop, stabilize and package the product to a desired texture. This method of manufacture includes, but is not limited to, forming and cutting ribbons to slices and packing with or without the application of non-tacking agent (such as an alginate, lecithin or starch solution), but can also include forming or extruding a product under pressure to blocks of any size.

Many formulations of the low fat processed cheese product are possible. Table 1 presents three possible formulations.

TABLE 1
Illustrative Formulations

| | Formulation 1 | Formulation 2 | Formulation 3 |
|---|---|---|---|
| | (Total Weight %) | (Total Weight %) | (Total Weight %) |
| SKIM MILK CHEESE | 38.117 | 54.000 | 39.921 |
| CHEDDAR CHEESE | 5.198 | | |
| HALF FAT CHEDDAR CHEESE | | 13.000 | 5.284 |
| ENZYME MODIFIED CHEESE | 1.101 | | 1.027 |
| CHEESE FLAVOUR | | 0.400 | |
| NON FAT DRY MILK | | | |
| SKIM MILK POWDER | 7.514 | 3.500 | 3.500 |
| MILK PROTEIN CONCENTRATE | 7.976 | 2.000 | 2.000 |
| WHEY POWDER | 4.797 | 2.000 | 2.000 |
| WHEY PROTEIN CONCENTRATE | 2.021 | | |
| SODIUM PHOSPHATE | 0.862 | 0.400 | 1.824 |
| SODIUM CITRATE | 1.994 | 1.600 | 1.328 |
| CALCIUM PHOSPHATE | 0.473 | | 0.563 |
| SODIUM CHLORIDE | 0.879 | 0.900 | 0.939 |
| LACTIC ACID | 0.66 | 0.800 | 0.704 |
| BETA CAROTENE | 0.0005 | | 0.003 |
| ANNATTO | | 0.010 | |
| TITANIUM DIOXIDE | 0.16 | | 0.146 |
| SORBIC ACID | 0.09 | 0.090 | 0.090 |
| INULIN | | 3.000 | |
| SODIUM ALGINATE | | | 0.411 |
| CARBOXYMETHYL CELLULOSE | | | 0.411 |
| WATER | 21.956 | 11.297 | 21.222 |
| CONDENSATE | 6.287 | 7.000 | 6.229 |
| VITAMIN D | 0.003 | 0.003 | 0.003 |
| General Characteristics | | | |
| Moisture | 53.5% | 55.0% | 53.5% |
| FAT | <3% | <3% | <3% |
| Protein | 26.7 | 26.7 | 25.0 |
| Functional Casein | 19.5 | 22.4 | 17.5 |
| Moisture/Functional Casein Ratio | 37.0 | 40.7 | 32.0 |
| Total Emulsifier | 2.856 | 2.000 | 3.152 |
| Citrate/Phosphate Emulsifier Ratio | 70/30 | 80/20 | 43/57 |

Some features of the present formulations are the emulsifier type and ratios, decreased moisture content, increased functional casein, and fat level of less than about 5 percent, but preferably less than 3 percent to provide a more natural flavor. The emulsifier type and ratios may help the product to run well in a chill roll function described below. As shown, a total emulsifier level of about 2 to 3 percent since the product contains high protein. Emulsifiers can include a citrate salt such as tri-sodium citrate. Optionally, a phosphate salt can be used as an emulsifier, such as di-sodium phosphate. Formulation 1 adds a calcium phosphate. Where both a citrate and phosphate salt are used in a formulation, the citrate will typically predominate, such as the 70/30 ratio in Formulation 1, and the 80/20 ratio of formulation 2. Nevertheless, a citrate/phosphate ratio can be up to 50/50. These ratios help to provide a flexible product that can run in a continuous ribbon during the chill roll operation. Formulation 1 can be suited to continuous ribbon manufacture. Formulation 2 can be suited for block formation. A higher phosphate to citrate ratio can result in brittle product that will have less flexibility.

Moisture content can be from about 45 to about 55 total weight percent, but preferably ranges from 53.5 to 55.0 total weight percent. The total protein fraction of the product can be 20 to 30 total weight percent, but preferably ranges from 25.0 to 26.7 total weight percent. The fraction of just the functional casein protein can range from about 12 to 25 total weight percent, but preferably ranges from 25.0 to 26.7 total weight percent. A moisture/functional casein can range from about 22 to 56 percent, but a ratio of about 36 to 41 percent, such as found in the first and second formulation, is preferred for continuous ribbon processes to provide a firm product that will not stick to the chill roll. Also, an anti-tacking agent such as, for example only, an alginate, lecithin or starch solution can be sprayed onto the cheese surface during cooling to reduce the tackiness of the surface to prevent slices from sticking to each other for ease of separation.

During manufacture, the ingredients are combined in a blender, such as a twin ribbon blender. The blend can then be cooked using a continuous cooker which achieves cook temperature and hold conditions to achieve desired shear and food safety requirements. In addition, the cooker steam injector provides the high shear required for appropriate emulsification. The cooked cheese can then be vacuum flashed to reduce the product temperature and to remove some of the moisture added via the condensation of steam. The cooked cheese can then be formed into slices using a chill roll and then packed. Optionally, the product can be extruded under pressure to form blocks of any size.

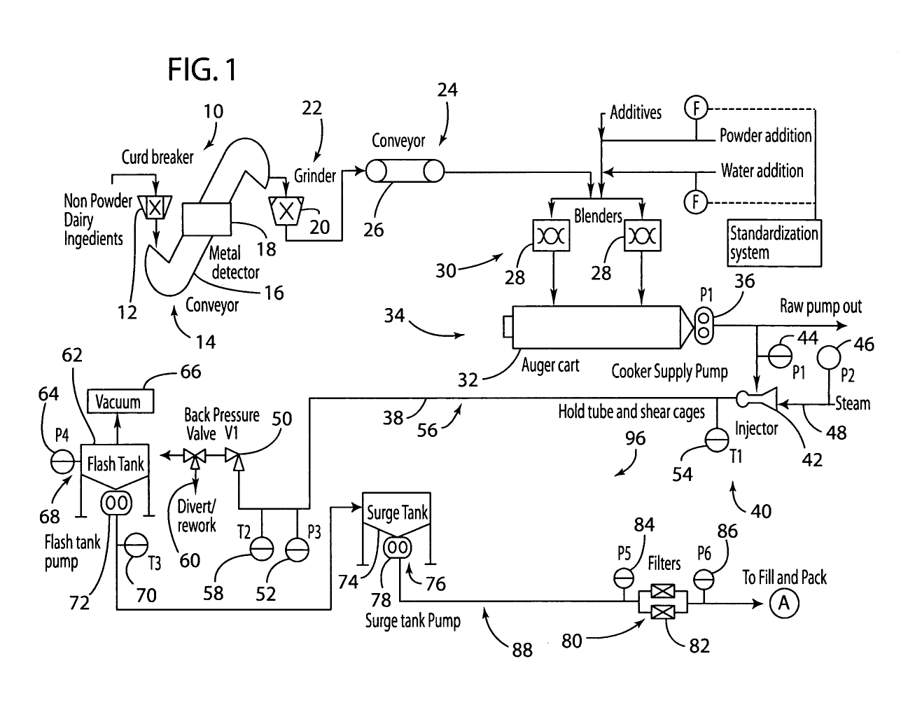

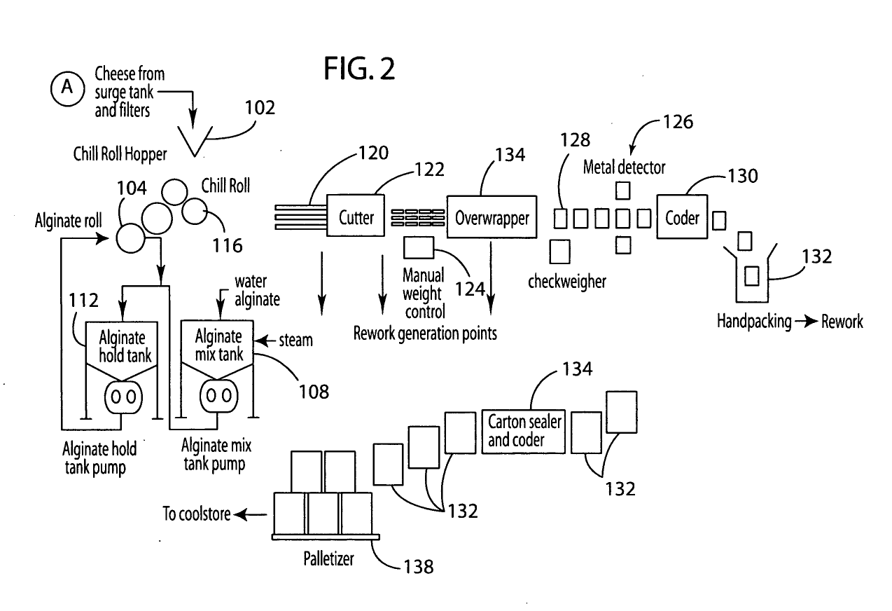

Methods for preparing substantially fat-free processed cheese products are illustrated in FIGS. 1 and 2. FIG. 1 illustrates a process flow diagram for blending and cooking the processed cheese product. FIG. 2 illustrates a flow diagram for slice fill and packing of the processed cheese product.

In FIG. 1, the steps of blending product components in formulations, such as shown in table 1, are illustrated by way of example only. At process step 10, a cheese blend, having non-powder dairy ingredients, such as various cheese components, and the like, are placed in a curd breaker 12 for breaking and grinding. As shown in table 1, the cheese blend can have skim milk cheese curd between about 30-80 total weight percent, but preferably from about 38-54 total weight percent, cheddar cheese between 0.0 and 10 total weight percent, and half fat cheddar cheese between 0.0 and 20 total weight percent.

At process step 14, the unmelted and un-emulsified blend of cheese particles is transferred to a grinder 20 via a first conveyor 16 having a metal detector 18.

At process step 22, the blend of cheese particles passes through a screen (not shown) of approximately 4.5 mm diameter (though other size diameters of, for example, 2-6 mm are possible) and into grinder 20. The purpose of this step is to reduce particle size and to avoid curd specks (unmelted and un-emulsified cheese particles in the cooked final product). A larger diameter screen size can be used where methods to make the cheese product include longer heating time in the hold tube.

At process step 24, the cheese blend is delivered to blenders 28 via a second conveyor belt 26. At process step 30, the cheese product is initially blended in blenders 28 for approximately 2 to 10 minutes. Blenders for the present method can be a ribbon (including a twin ribbon) and paddle blenders. It is noted that other embodiments could also combine in various combinations the steps of breaking, grinding and blending that result can result in a comparable homogeneous mixing.

Next, while still in blenders 28, a first group of powders can be added. Group 1 powder additions can be standard addition quantities intended to minimize total blend preparation time. Group 1 additions can be predetermined and set for a desired formulation. The amount added at this point can typically be between 60 to 90 percent of the estimated total weight percent desired and listed herein. Group 1 powders can include:

milk protein concentrate (MPC) between 0.0 and 8 total weight percent;

whey powder between 0.0 and 5 total weight percent;

tri-sodium citrate between 1 and 3 total weight percent;

acid modified starch, optionally between 0.0 and 4 total weight percent; and

non fat dry milk (skim milk powder) between 0 and 8 total weight percent.

Again, it is noted that the amount given immediately above is the total weight percent for the final formulation, and not the 60 to 90 percent fraction added at this step of the overall process. The MPC can be an 80 percent protein. Other protein levels can be used by modifying formulation to reach a desired final product protein level. The acid modified starch and an optional texture modifier like hydrocolloids (such as alginate, cellulose, gums, and the like) may be desired in some low milk protein formulations to modify the texture of the final product to be more consistent with conventional processed cheese products. Sodium citrate is an emulsifier. Once added, a two minute mixing cycle continues to ensure adequate mixing. Next, as the blend continues to mix, a portion of water can be added to enable adequate hydration of powders and homogenous mixing. Control over powder and water balance is an important aspect in achieving correct homogeneous mixing. The proportion of water can vary from about 40 to 90 percent of the total portion of water added ranging between 11 and 22 total weight percent.

Process step 30 continues with the addition of a first group of additives, such as supplemental nutrients, color or preservatives. For example:

β-Carotene or annatto between 0.00 and 0.003 total weight percent;

vitamin D and/or vitamin A between 0.00 and 0.003 total weight percent depending on level of fortification desired;

titanium dioxide between 0.00 and 0.16 total weight percent; and

sorbic acid between 0.00 and 0.09 total weight percent.

Once added, the blending continues at least 30 seconds to one minute to ensure adequate mixing. It is noted that no dry powders should be visible prior to addition of any coloring.

Process step 30 continues while still in blenders 28, with the addition of a second group of powders. Group 2 powder additions can be standard addition quantities intended to minimize total blend preparation time. Group 2 additions can be predetermined and set for a desired formulation. They can include the remaining powders of the estimated amount required that were not added with the Group 1 powders. Group 2 powders can include:

tricalcium phosphate (TCP) between 0.00 and 0.6 total weight percent;

remaining tri-sodium citrate (TSC) between 1.3 and 2 total weight percent;

di-sodium phosphate (DSP) between 0.400 and 1.824 total weight percent;

salt between 0.00 and 0.563 total weight percent;

remaining MPC between 2 and 8 total weight percent;

remaining whey powder between 2 and 5 total weight percent; and

remaining skim milk powder between 3.5 and 7.6 total weight percent.

Sodium phosphate can be an additional emulsifier. The salt can be sodium chloride, potassium chloride, or salt substitute, in various combinations of potassium and sodium chloride. Also, whey protein can be added to the group 1 and/or group 2 powders.

Process 30 continues with additional blending time to ensure adequate mixing, followed by the addition of the remaining water to ensure the powders are adequately hydrated. This can be followed by additional blending to ensure homogeneous mixing. Next, lactic acid can be added between 0.66 and 0.800 total weight percent for pH standardization. pH standardization can range from about 5 to 6, with a preferred pH of 5.35 to 5.65. The blend can then be mixed again to ensure homogeneous mixing.

Once the last blending step is complete, a representative composite sample can be taken for lab analysis as required. Results of chemical analysis can be entered in a standardization system, which can indicate whether moisture, salt, and pH are within the recommended ranges. Adjustments can then be made as indicated from the sample results and the product, and then retested. Additional mixing time can also be added if desired, but typically should not exceed 20 minutes overall.

It is noted that many variations in blending steps and formulations are possible and still fall within the anticipated formulations of the present product. Optional components in other formulations can include: buttermilk powder, whey protein, corn syrup, cheese flavor, annatto, inulin, sodium alginate, carboxymethyl cellulose, carrageenan, condensate, and vitamin A. Carrageenan is a seaweed derivative and used as a hydrocolloid to influence texture and/or viscosity of the product. Other types of hydrocolloids known in the art could also be considered. Annatto is an oil and can be used for coloring the product.

After these steps are complete, the uncooked product can then be discharged to an auger cart/assembly 32 at process step 34. Care must be taken to minimize mixing in auger assembly 32. Extended mixing in auger assembly 32 can adversely affect product consistency and therefore performance on chill roll. From auger assembly 32, a cooker supply pump 36 can transfer the uncooked product into a continuous steam injection cooker 38. Pump speed is regulated to produce an injector cooking rate sufficient to achieve the time/temperature product cook and hold tube conditions; emulsification for desired cheese texture; and energy efficiency targets. Pump 36 can be a multi-lobed positive displacement pump having low shear and low pulsing to minimize work on the uncooked product.

As pump 36 drives the product into the steam injector 42 and hold tube 38, the process step 40 of cooking the product begins. Generally, the product can be cooked at between 105 to 125° C. (preferably 110° C.). Specifically, cooking at process step 40 can be achieved by the introduction of steam to the product at an injector 42. Pump 36 pumps the product into injector 42 at an injector pressure P1 (44) ranging from 300 kPa to 750 kPa with a target pressure of about 600 kPa. Injector pressure 44 can be adjusted within a target range to ensure efficient heat transfer to enable emulsification and efficient mixing. Steam can be introduced to the product by a steam line 48 into injector 42 at a pressure P2 (46) ranging from 400 kPa to 850 kPa with a target pressure of about 700 kPa. Injector pressure differential is the pressure difference between the injector pressure P1 44 and the controlled steam pressure P2 46. Injector pressure 44 should be kept lower than the controlled steam pressure 46 to avoid product entering steam line 48. The minimal differential should be about 50 kPa, with a target of about 100 kPa. Product then enters hold tube 38 at a temperature T1 54 ranging from between 105 to 125° C. (with a target of about 110° C.).

A back pressure value 50 is illustrated at the exit of hold tube 38. Back pressure valve 50 creates a back pressure P3 52 to keep the hold tube 38 full so as to properly cook and emulsify the product, while also avoiding product/vapor separation (flashing). Back pressure P3 52 can range from about 50 kPa to 150 kPa, with a target of about 100 kPa. The cooker hold tube and shear cages 38 shim size can be adjusted to achieve desired emulsion at the required throughput. Further, hold tube 38 can be water cooled via a water jacket (not shown) to minimize product burn.

Next, process step 56 holds and cooks the product in hold tube 38. Hold tube 38 should be kept full of product during operation to achieve a desired hold time (3 to 15 seconds preferred) and temperature, to ensure the product is cooked, and to ensure emulsification due to initial shear achieved by steam and shear cages. A target T2 58 (preferably about 95° C.) can be maintained to ensure under-processed product can be automatically diverted and discarded through line 60. The product can then be delivered to flash tank 62.

Next at process step 68, vacuum flashing is created by a vacuum 66 connected to flash tank 62. Flash tank vacuum can have a pressure P4 60 to achieve a cheese exit temperature (T3 70) of about 75° C. to 85° C. Flash tank 62 should have as low a level of product as possible to minimize creaming, an alignment of proteins leading to a firming of the texture. Chill roll hopper temperature described below can be controlled at this point in preparation for the product transfer to the chill roll. At a point when T3 70 is acceptable, a flash tank pump 72 delivers the cooked product to a surge tank 74.

Next at process step 76, the product can be held in surge tank 74. Surge tank 74 keeps as low a level of product as possible to minimize creaming. A surge tank pump 78 can then deliver the product to the filters.

Next at process step 80, the product can pass through in-line filters 82 to remove any extraneous matter or any un-emulsified curd specs. Process step 82 also monitors product pressure before filtration at P5 84 and after filtration at P6 86. P5 84 and P6 86 can be used to indicate when a filter change is necessary. A blocked filter may impart high shear on the product and lead to a broken emulsion or other less desirable characteristic

At this point the blending and cooking of the product is complete and exits FIG. 1 at point A, which is continued in FIG. 2. FIG. 2 illustrate the next stage of processing the product, which is the chill rolling and packing. As shown, the cooked cheese product is delivered from surge tank 74 and filters 82 to chill roll hopper 102. As indicated above, the temperature at this point is controlled at the flash tank 64 (T3 70) and is adjusted to achieve the desired cheese product sheet texture. From chill roll hopper 102, the cooked product can be formed into sheets and, as shown, an alginate solution can be applied to the product surface to reduce any adhesive tendencies of the product. Other anti-tacking agents such as a lecithin or starch solution are possible.

The alginate solution can be formed by supplying water, alginate powder and heating in an alginate mix tank 108 and 112. Next, the alginate solution can be transported to the chill roll and applied via spray/drip nozzles onto chill roll 104 or to slices 120.

The product with the alginate solution on its surfaces can next pass through a plurality of chilled rollers 116. Chilled rollers 116 are maintained at a temperature of 15° C. maximum. If the temperature falls below 6° C. the cheese product can be too firm and slices can be too brittle, resulting in issues at the cutter. If the temperature is above 15° C., the product may become difficult to slice. Alternate chill roll temperature ranges can vary slightly with alternate formulations.

The cooked and chilled product next travels through a series of cutters 118 configured for the desired application. Optionally, product can also run through a former to shape as a block.

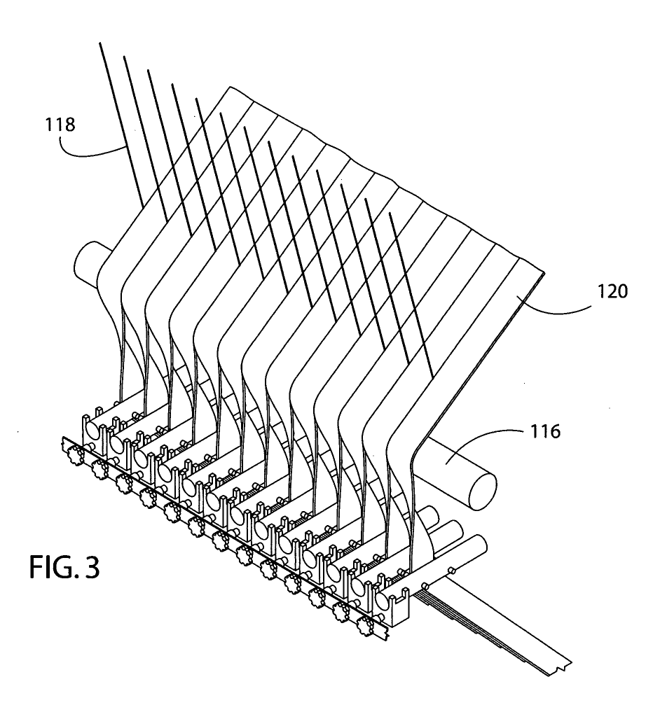

As shown in FIG. 3, cutters 118 can be slitters that cut the cheese product into ribbons 120 (or maintain the ribbons) as it passes chilled rollers 116. When individual cheese slices are the desired final configuration of the product, cutters can cut ribbons 120 to a desired slice width, such as, for example only, a slice width of 90±2 mm. Spooling machines can stack the individual slices, including with a 2 to 4 mm alternating offset (stagger). Predetermined stack sizes, such as for example 6-15 slices, can be determined using a weight scale 124.

Next the final stacked product can be package using an overwrapper 134, which uses a cold seal film. The overwrap can be a suitable, preferably substantially gas impermeable, substantially light-impermeable packaging material, which forms a substantially hermetically sealed package around the individual slice-on-slice stack. The sealed, overwrapped package provides the consumer with a sealed unit containing a plurality of slices which may be removed when needed by the consumer.

From here quality assurance steps 126 can be taken for product packages 128 using a scanner, such as a metal detector and a weight scale to check for missing slices. If a product package 128 passes step 126, it can be coded by coder 130 and packed in a carton 132. From here, cartons 132 can be coded with a use by date and sealed by carton sealer and coder 136. Next cartons 132 can be placed on a pallet 138, then sent to cool storage.

While the products and methods have been described in conjunction with specific embodiments, it is evident that many alternatives, modifications, and variations will be apparent to those skilled in the art in light of the foregoing description.

We claim:

1. A low fat processed cheese product comprising a substantially homogeneous mixture of:
from about 30 to 54 total weight percent of natural skim milk cheese;
additional non-powder dairy ingredients;
less than about 3.0 total weight percent fat;
from about 53 to about 55 total weight percent of water;
from about 2 to about 2.8 total weight percent of emulsifier salts, the emulsifier salts being at least a citrate salt;
from about 25 to 26.7 total weight percent protein, of which from about 17 to 22.5 total percent weight is functional casein protein; and
moisture/functional casein protein ratio from about 32 to 41 percent.

2. The cheese product of claim 1, wherein the emulsifier salts further comprise a phosphate salt, and wherein a citrate/phosphate ratio ranges from about 70/30 to 80/20.

3. The cheese product of claim 1, further comprising an anti-tacking agent on its surface.

4. The cheese product of claim 3, wherein the anti-tacking agent is an alginate.

5. The cheese product of claim 3, wherein the anti-tacking agent is lecithin.

6. The cheese product of claim 3, wherein the anti-tacking agent is a starch solution.

7. The cheese product of claim 1, wherein the citrate salt is di-sodium citrate.

8. The cheese product of claim 2, wherein the phosphate salt is tri-calcium phosphate.

9. A method for preparing a low fat processed cheese product of claim 1 comprising the steps of:
breaking and grinding cheese curds and dairy solids;
detecting extraneous materials;
blending dairy solids with a first group of powders and an amount of water sufficient to hydrate the powders, the first group of powders comprising from about 60 to 90 percent of the total amount desired of milk protein concentrate (MPC), whey powder, citrate salt, and skim milk powder;
blending in additives of beta-carotene, vitamin D, titanium dioxide, and sorbic acid;
adding sufficient water to hydrate powders and facilitate homogeneous mixing as they are added;
blending in salt and the remaining citrate, MPC, whey powder, skim milk powder;
standardizing pH of the blend with lactic acid;
cooking the blend;
vacuum flashing the blend;
filtering the blend; and
chilling the blend.

10. The method of claim 9, further comprising the steps of:
forming the blend into a sheet; and
applying an anti-tacking agent to the surface of the sheet.

11. The method of claim 9, further comprising the steps of:
extruding the blend in a former under pressure to form a block.

12. The method of claim 9, wherein the blending is performed by a double ribbon blender.

13. The method of claim 9, wherein cooking the blend comprises the step of heating the blend with a steam injector then holding in a hold tube from about 3 to 15 seconds at from about 105° C. to 125° C. and under pressure from about 50 kPa to about 150 kPa.

14. The method of claim 10, wherein the anti-tacking agent is alginate.

15. The method of claim 10, wherein the anti-tacking agent is lecithin.

16. The method of claim 10, further comprising the steps of:
slitting the sheet into continuous ribbons;
cutting the ribbons into individual slices; and
stacking the slices with a 2 to 4 mm alternating overlay.

17. The method of claim 10, further comprising the steps of:
scanning the product with a metal detector;
overwrapping the stack of slices in a sealed container; and
cooling the container with the stack of slices to 6-15° C.
